(19) United States
(12) Patent Application Publication
(10) Pub. No.: US 2015/0193468 A1
(43) Pub. Date: Jul. 9, 2015

(54) METHODS AND APPARATUS FOR SUMMARIZING AND PRESENTING DATA BASED ON USER ACTIONS AND LOCATIONS

(71) Applicant: InterDigital Patent Holdings, Inc., Wilmington, DE (US)

(72) Inventor: Mona Singh, Cary, NC (US)

(21) Appl. No.: 14/149,415

(22) Filed: Jan. 7, 2014

(51) Int. Cl. G06F 17/30

(52) U.S. Cl. CPC G06F 17/30241; G06F 17/3087

(57) ABSTRACT

The present application pertains to methods and apparatus that maybe implemented in a location-aware mobile communication device for organizing and displaying location-specific information from a plurality of software applications. In one embodiment, the method comprises interfacing with each of the plurality of software applications to gain access to information items available through the software applications, reviewing the information items to identify location-specific data in the information items indicative of a location salient to the information item, maintaining a database indexing the information items as a function of the salient locations, responsive to a location-specific event corresponding to a specific location, identifying information items in the database having salient locations with a particular geographic relationship to the specific location, and controlling a display device to display a representation of the identified information items on the mobile communication device.

### FIELD OF THE INVENTION

This disclosure pertains to communication networks and mobile communication devices. More particularly, the disclosure pertains to location-based services in mobile communication devices.

### BACKGROUND

Users of mobile communication devices such as cell phones, and particularly smart phones, use such devices for so many different purposes and in connection with so many different software programs (applications or apps) in their day to day lives that it is becoming increasingly difficult to organize all the data stored on or otherwise available through such devices. Such devices typically have little or no means for organizing data across multiple apps. Furthermore, even within a single app, it is often difficult or time-consuming to access and/or view a specific item of data in which a user is interested.

Mobile telephones and other mobile communications user equipment often are equipped with geo-location mechanisms, such as GPS (Global Positioning System) software and hardware, that enables the device to determine its geographic location (location-aware devices).

### SUMMARY

The present application pertains to methods and apparatus that may be implemented in a location-aware mobile communication device, for organizing location-specific information from a plurality of software applications. In one exemplary embodiment, the method comprises interfacing with each of the plurality of software applications to gain access to information items available through the software applications, searching the information items to identify location-specific data in the information items indicative of a location salient to the information item, maintaining a database indexing the information items as a function of salient location, responsive to a location-specific event corresponding to a specific location, identifying information items in the database having salient locations having a particular geographic relationship to the specific location, and controlling a display device to display a representation of the identified information items on the mobile communication device.

### BRIEF DESCRIPTION OF THE DRAWINGS

A more detailed understanding may be had from the following description, given by way of example in conjunction with the accompanying drawings wherein:

FIGS. 1A-1D show one exemplary progressive series of user interfaces for displaying location-based summary information in accordance with an embodiment of the invention;

FIG. 1E shows an alternative embodiment to the user interface shown in FIG. 1B.

FIG. 1F shows another alternative embodiment to the user interface shown in FIGS. 1B and 1E.

FIG. 2 shows an exemplary alternate user interface for displaying location-based summary information in accordance with an embodiment of the invention;

FIG. 3 is a block diagram illustrating one embodiment of an architecture of a system in accordance with the principles of the present invention;

FIG. 4 is a flow diagram illustrating processing steps in accordance with one exemplary embodiment of the invention;

FIG. 5 is a flow-diagram showing a detailed exemplary embodiment of step 401 of FIG. 4;

FIG. 6 is a flow-diagram showing a detailed exemplary embodiment of step 403 of FIG. 4;

FIG. 7A is a system diagram of an example communications system in which one or more disclosed embodiments may be implemented;

FIG. 7B is a system diagram of an example wireless transmit/receive unit (WTRU) that may be used within the communications system illustrated in FIG. 7A; and

FIGS. 7C, 7D, and 7E are system diagrams of example radio access networks and example core networks that may be used within the communications system illustrated in FIG. 7A;

### DETAILED DESCRIPTION

Users of mobile telecommunication devices, such as smartphones and the like, commonly store many pieces of information (hereinafter sometimes referred to as information items) on their devices that are related in some way to a particular geographic location (hereinafter sometimes referred to as location-specific information or location specific information item). Additional location-specific information may not be stored directly on the device, but may be available through the device via a communication network. For instance, other such information may be stored in the “cloud” or on other communication devices of the user that are accessible to the present communication device via a network. Merely as one example, a user might conduct extensive research that is relevant to a particular location at which the user expects to be in the near future, such as in anticipation of a vacation to that location, and store that information ahead of time via one or more apps available on or through a mobile communication device. Thus, the user may have stored on his/her smartphone location-specific information in various different forms and/or associated with various different apps. Merely as a few examples, this may include hotel reservations, rental car reservations, restaurant reservations, travel itinerary, schedule of events, weather information, maps, travel books, news or magazine articles about the location, photographs of the location, video of the location, etc. Such information may be stored on (or otherwise available through) the smartphone via a multiplicity of apps, including, for instance, an email app, a calendar app, a web browser app (e.g., browser history and bookmarked web pages), an address book app, and various specialty apps, such as apps offered by a rental car company, airline, or travel web site for convenient creation of reservations and updating of travel information.

Also, not that the term store is used broadly herein, and encompasses both explicit storing (i.e., a store effected by explicit user action, such as storing a word processing document) as well as implicit storing, where the device stores information without any express act of the user requesting or effecting storage (e.g., a web browser that implicitly is storing search history).

It can be time-consuming and/or difficult for the user to find and/or cause the mobile device to display all such information (or any specific piece or pieces of such information) that may be needed when the user is at the location, e.g., what time is dinner, what is the name or location of the restaurant, who is attending dinner, how far away is the restaurant, what is the dress code, etc. For instance, such information could be stored in a number of different apps and, even within a single app, such information could be stored in a number of different files or locations (e.g., different e mails within an e mail app, different PDFs, different word processing documents, different bookmarked web pages, etc.). The user may have to comb through email messages, browser history, browser bookmarks, saved documents, apps, etc. to find all of the desired information.

As another example, a user may have conducted an online search for a particular item to purchase. However, when the user arrives at the store, the user may not be able to find the item and may wish to find a previously viewed web page or picture of the item in order to show it to a sales person at the store, who may be able to direct the user to the item.

In yet another example, a user may be at a doctor's office, wherein it may be useful to have readily available on a mobile communication device the patient web portal, prior searches about a medical condition, receipts that came by email, spouse's reminder to ask the doctor a specific question, future appointments, etc.

In accordance with an embodiment of the invention, a location-aware mobile communication device is adapted to determine the present location of the device (e.g., using geo-positioning software and/or equipment, such as GPS and/or a cellular network triangulation and/or trilateration system), access various software applications on or available through the device and search for and collect information stored in association with those software applications relevant to that location. The device is then configured to display such information to the user on a graphical user interface on a display device of the mobile communication device in a manner that is easy and convenient to view and navigate through. The location of choice need not be the device's current location and, in fact, the device need not even be a location-aware device. Rather, any location corresponding to a location-specific event of which the device has knowledge may trigger the aforementioned operation. For instance, the device may be adapted to permit the user to manually select a location (which may be a location other than the current location of the user and/or device) such as by navigating to it on an interactive map or typing in a location (e.g., by coordinates, address, or name). An interactive map may be provided as part of a software package including features of the invention or may be a separate interactive map app resident on or available through the device with which the software may interface.

Different locations often have unique significance in a user's mind. In accordance with an embodiment, if a user travels to a location that is salient (or different in a salient way from the user's previous location), the software causes the new location to appear on the screen of the mobile device (which may, for instance, involve opening an interactive map) and display a synopsis of location-specific information items salient to the new location that are gathered from one or more apps available on or through the device.

As will be described in greater detail below, the synopses may be presented in the form of a list or other graphical representation of summaries of the various pieces of location-specific information. Each summary might be in the form of a brief textual description of the information item or an icon representative of the information item. The icon may be presented on a map in a position corresponding to the salient location of that information item. The user may interact with any one of the information items, such as by “clicking” on its icon (or other summary representation) to “open” the app and/or the corresponding information item within that app.

In accordance with one embodiment, the software package interfaces with other applications on or available through the device, e.g., through suitable APIs (Application Program Interfaces) and networks and gathers information from the user's interactions across multiple devices and applications and indexes them as a function of salient locations. If the device is able to access information from the cloud and/or other of the user's communication devices, (e.g., desktop computer, laptop computer, tablet computer, other mobile devices, etc.), it may interface with apps on those other devices or cloud storage to gather information from those devices also.

Examples of some apps and information items available thereby therein include, but are not limited to: email messages in e mail apps; bookmarks in web browsers; browser history in web browsers (pages the user has interacted with may have a higher ranking than others); photographs; videos; other apps on a mobile device; text messages in SMS apps; schedules in Personal Information Management and Calendar apps, and documents in word processing apps.

An information item may comprise any piece of information that is comprehensible in its own right. Some examples of information items include a web page, a document, a media file, and an email message. Some items can contain other items. For example, an email thread can contain more than one email message.

Each information item may be indexed according to one or more salient locations and stored in a database. An information item may have more than one salient location (e.g., a train ticket for traveling from Cusco to Machu Picchu should be indexed to both locations). Information items that have no discernible salient location may be ignored or indexed to a special salient location, such as “unknown”.

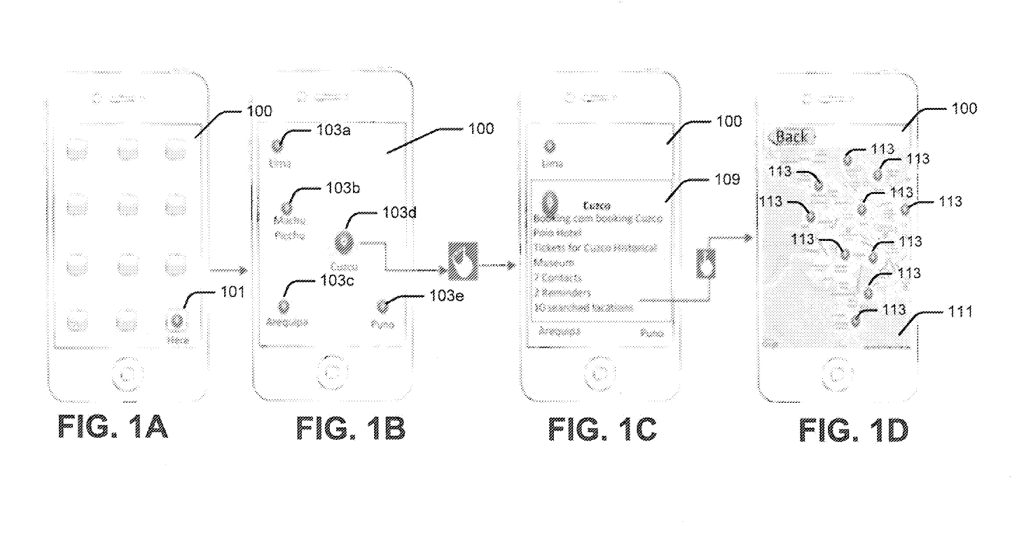

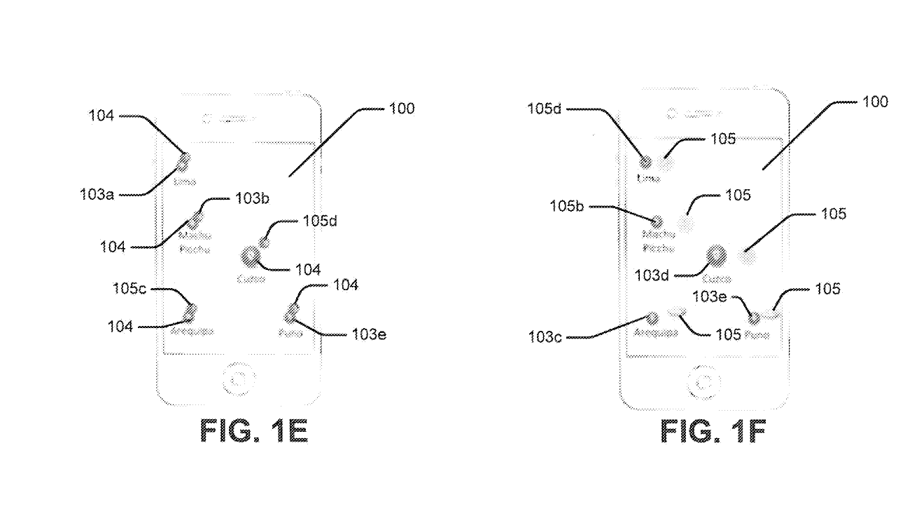

FIGS. 1A-1D show one exemplary series of Graphical User Interfaces (GUIs) for displaying location-based summary information. Referring to FIG. 1A, in this example, the invention is implemented as an app available on the mobile communication device that the user may launch (such as by tapping on the folder or other icon 101 on the screen 100 corresponding to the app). In this exemplary embodiment, launching the app will cause the app to generate a user interface as shown in FIG. 1B, which displays a set of icons 103a-103e corresponding to regions, in this example, cities. However, regions may take many other forms, including, for example, states, countries, neighborhoods, user-defined regions, areas within a specified distance of a point, etc. The icons may be as simple as names of the regions, (e.g., city names, neighborhood names, state names, addresses, restaurant names, etc.). In some embodiments, some or all of the regions and/or names of the regions may be assigned names of personal significance to the user (as preprogrammed by the user, for instance), such as Home, Work, School, Mom's House, etc. The size of the icon corresponding to each region may be proportional to the number of information items indexed to salient locations within or near that region.

The set of regions may be presented as a simple list. The list may be organized in any reasonable manner, such as by function of distance from the current location of the device (or another location selected by the user). The list may include all regions for which information items stored in the information item database have salient locations within a region or within a predetermined distance of a region or point. Alternately, it may comprise only those regions within a particular distance of a particular location, such as the present location of the device/user (or any other location specified by the user). The predetermined distance may be configurable by the user. In one embodiment, the user may select the aforementioned distance and/or geographic area through navigation in an interactive map. For instance, the user may be enabled to select the geographic region displayed on a touch screen by sliding the map to the desired geographic area and/or select a scale of the map using a pinch-to-zoom feature or the like, (e.g., the geographic area within which regions corresponding to salient locations will be displayed may be the geographic area displayed on a map on the user interface of the device).

In some embodiments, the regions may be presented in map form (e.g., overlaid on a map with each location positioned at the actual corresponding location on the map). In yet other embodiments, the regions may be presented in map form, but without being overlaid on a map, e.g., with each salient location presented in a position relative to the other displayed salient locations that corresponds to their relative actual physical locations, but not overlaid on a map showing other geographic or topological features (e.g., as shown in FIG. 1B). In either of the map embodiments, the GUI may also show the user/device current location for ease of reference by the user. In any of the above described embodiments, the interface also may show the actual distances to the regions from the user's current location.

The granularity of the regions displayed may change as a function of the scale of the map and/or predetermined distance. For instance, if the selected area comprises over 200 square miles, the regions may be presented on a city by city scale, but for areas of less than 200 square miles, the regions may be presented on a neighborhood by neighborhood scale. The granularity may change visually on the GUI in real time as the user alters the scale of the area of interest (such as by using pinch-to-zoom on a map display).

In an alternative embodiment illustrated in FIG. 1E, which shows an alternative user interface to that shown in FIG. 1B, a number 104 of information items with salient locations within each region may be displayed in proximity to the region icon 103a-103e.

In yet other embodiments (not shown), the count of each different type of information item corresponding to each region may be shown separately (e.g., 3 web searches, 1 calendar event, 2 emails).

In yet another alternative embodiment as illustrated in FIG. 1F, regional weather information 105 may be displayed in proximity to each region icon 103a-103e.

The user may interact with each region shown on the GUI to see the information items corresponding to that location. For instance, in a mobile communication device with a touch sensitive screen, the user may select one of the displayed regions by tapping on the corresponding icon 103a-103e. This may cause the display to display an interface like that shown in FIG. 1C or FIG. 1D. In FIG. 1C, the icon 103d corresponding to the selected salient location (e.g., the city of Cuzco) is expanded to show a list 109 of the information items indexed under salient locations within that selected region. In other embodiments (not shown), instead of just expanding, the entire display may be changed to display the list 109.

In yet other embodiments, the set of information items may be displayed on another (e.g., smaller scale) map 111 corresponding to the selected region, such as shown in FIG. 1D, with an icon 113 for each information item. Each icon 113 may be shown in a position on the map 111 corresponding to the salient location of that information item. For instance, the region interfaces in FIGS. 1B, 1E and 1F are on a city by city scale. Once the user selects one of the regions e.g., Cuzco, the information items are then displayed in the interface of FIG. 1D on a map that is of smaller scale, e.g., a city-sized scale

Note that, in yet other embodiments, the entire region display and selection steps (e.g., FIG. 1A, 1B, 1E or 1F) may be omitted. That is, instead of first displaying a plurality of regions from which the user selects one particular region for displaying location-specific information items, the software instead starts by displaying the location-specific information items themselves that are indexed to a salient location that is within whatever geographic area is selected (as in FIG. 1C or 1D, for example). For example, launching the software may cause the software to generate a user interface which shows a map of a predetermined (or user selected) scale centered on the user's current location and showing icons corresponding to each location-specific information item whose salient location is within the displayed geographic area. Similar to that described above with respect to the displaying of the regions, each icon may show the names of the salient location corresponding to that information item (e.g., city names, neighborhood names, state names, addresses, restaurant names, etc.). In some embodiments, some or all of the names of the regions may be assigned names of personal significance to the user, such as Home, Work, School, Mom's House, etc. Alternately or additionally, the icon may disclose something about the information item other than its salient location, e.g., the app from which it originated, the nature of the item (a restaurant reservation), the type of information item (an email), etc. Again, just as described for the display of regions: (1) the set of information items may be displayed as a simple list; (2) the list may be organized in any reasonable manner, such as by distance from the current location of the device (or a location selected by the user); (3) it may comprise only those information items with salient locations within a particular distance of a particular location, such as the present location of the device/user or any other location specified by the user; (4) the predetermined distance may be configurable by the user; (5) the information items may be presented in map form (e.g., with each information item positioned at the actual corresponding salient location on the map) with or without being overlaid on a map showing other geographic data; (6) the GUI may show the user/device current location; and (7) the interface also may show the actual distances to the salient location from the user's current location.

In some embodiments, the set of information items displayed may also indicate the app from which each information item was retrieved. For example, a well-known icon for the particular application may be displayed as the information item icon 113 itself or as a separate icon displayed next to or otherwise in association with the information item icon 113. In other embodiments, only the nature of the app may be displayed, without specifying the exact app, e.g., “web browser”, “email”).

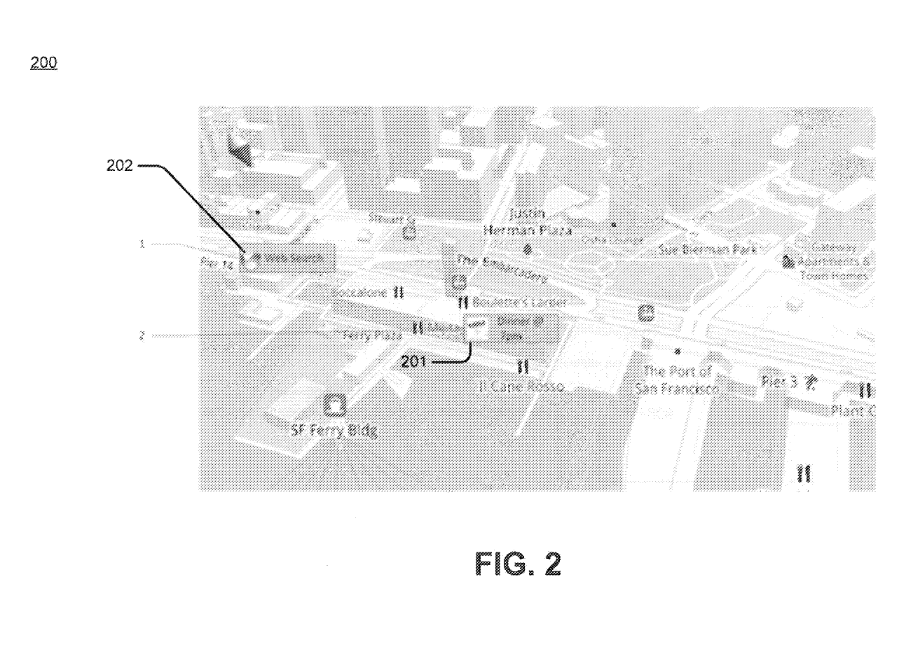

FIG. 2 shows another, more detailed example of a user interface 200 like that of FIG. 1D for displaying the location-specific information items in a map-like GUI. In this example, the user has selected the Embarcadero neighborhood of San Francisco as the salient location. The device displays a map (in this example, it is a 3-D fly-over type map view) on which two information items 201 and 202 are displayed. The first information item 201 is an appointment for dinner at a restaurant at 7 PM. This information item may have been captured, for example, from a reservation web site or from an email on any of the user's communications devices. The user may select information item 201 by tapping it on a touch-sensitive screen of the mobile device, which will cause the device to open the relevant app, e.g., a web browser, and open the relevant web page for that reservation.

The second information item 202 is a web search that the user had previously conducted that, in some way, corresponded to Pier 14 as its salient location. Perhaps it was another restaurant that the user had searched or simply a location that the user had typed into an Internet search engine. Alternately, the user can select information item 202 to open the web browser and be brought to the relevant web page.

In some embodiments, the user may be enabled to select the types of information items to be displayed. For example, a checklist may be provided to allow the user to select the applications from which information items are to be displayed. Then, only information from those selected applications would be considered for display.

As previously mentioned, the actual information item can be almost any piece of electronic information, such as an e mail, a web page, a user interface in another app, a word processing document, etc.

Further details about various aspects of the invention are presented below, starting with an exemplary architecture for implementing the present invention.

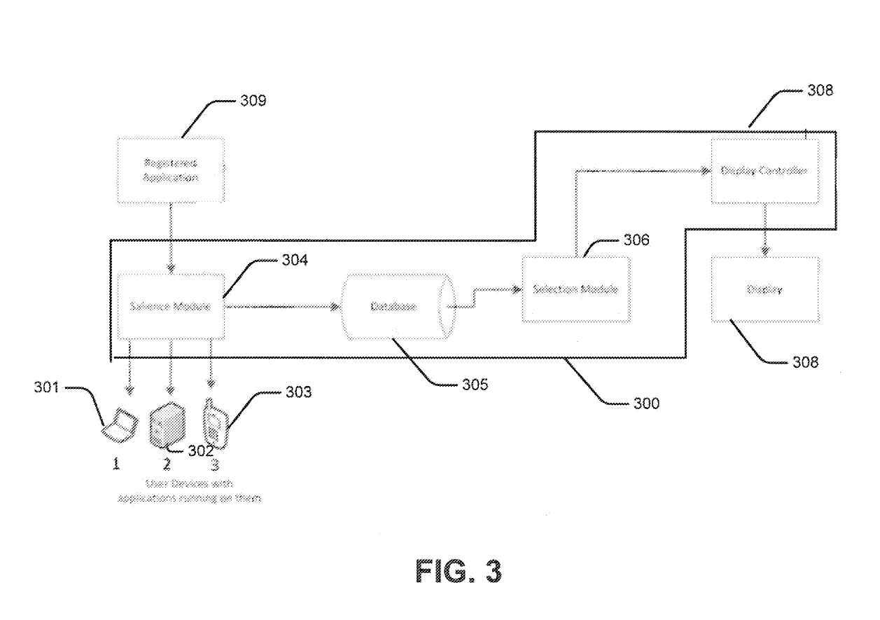

FIG. 3 shows one exemplary architecture. In this embodiment, the user has three communications devices, namely, a laptop computer 301, a desktop computer 302, and a smartphone 303. Each device may run applications such as web browsers, apps, Personal Information Management (PIM) applications, calendar applications, messaging applications, email, and document creation applications. Devices 301, 302, and 303 are location-aware. The devices may be self-contained in this regard or rely upon infrastructure to determine the user's location.

The user may register one or more software applications 309 resident on or available to (through the cloud, for instance) any one or more of those devices 301, 302, 303 with a system operating in accordance with the principles set forth herein (hereinafter the Location Module 300). The term Registered Application will be used hereinafter to refer to any application that provides information items for possible storage and retrieval by the Location Module 300. The Location Module 300 and its various parts may, for instance, be formed from software, firmware, hardware, or any combination thereof.

Almost any type of software application 309 may be useful to register and use with the Location Module 300. However, a short list of some of the more beneficial applications include web browsers, video recorders, still cameras, internet search applications, travel applications, navigation and mapping applications, email applications, personal digital assistant applications, personal contacts database applications, calendar applications, and word processing applications. The Location Module may be equipped with suitable APIs (not shown) for interfacing with the registered applications so that the Location Module can search and retrieve location-specific information items from the registered applications.

The Location Module 300 includes a Salience Module 304. The Salience Module 304 analyzes user interactions and identifies information items within the registered applications 309 that relate to an identifiable location and tags them with that location. Thus, the Salience Module 304 contains logic for identifying information items that contain references to locations. This functionality may be implemented on an application-by-application basis or by using more general information retrieval techniques. Merely as a few examples, the Salience Module 304 may associate a web page from the user's browser history with known location names mentioned on that page. Further, it may associate an image, video, or audio file with the location information (GPS coordinates) commonly included in the metadata of the image, video, or audio file. Yet further, it may associate any media file with locations referenced in its contents. For example, this can comprise a city name mentioned in a song or in the title of a song. The Location Module may maintain a database of known location names or may query resources available remotely to the device through a communication network. The Salience Module 304 passes the above information (e.g., information item and the salient location associated with the information item) to an Information Store 305 for storage.

The Information Store 305 stores the information items indexed by the associated locations. This information store 305 could be placed on the device, as shown in FIG. 3 (e.g., if the device forms part of a motor vehicle) or could reside externally and be accessed by the Location Module 300 via a web service. The web service could be hosted on the cloud or on a dedicated server. Major providers of hosting solutions for web services include, for instance, Google (https://developers.google.com/appengine/) and Amazon (http://aws.amazon.com).

The method for indexing information items by salient location may be any of several that are well known. Merely as one example, the information store 305 could (1) store all information items in a database table with a key and/or (2) store for each location a list of all keys of associated information items.

A Selection Module 306 determines the user's current (or selected) location and retrieves and ranks the relevant information items from the database 305 as a function of that location. The Selection Module 306 selects the appropriate information items and forwards them to the display controller 307.

A Display Controller 307 renders the information to be presented to the user on a display 308, such as by using any of the GUI's shown in FIGS. 1A-1F and 2 or otherwise discussed hereinabove. For example, the Display Controller 307 can display a map of the region near the user's current (or selected) location and show pins corresponding to the salient locations within the map region. As previously mentioned, it may also display for each such location the number of information items indexed under each such salient location. Suitable map-based interfaces are common and well known, including, for example, (http://googlecode.blogspot.com/2009/05/how-to-make-maps-center-of-your-ui-and.html)

Display 308 may be any type of display, including, but not limited to, a windshield display, a wearable computer (e.g., glasses), a smartphone or computer screen, a navigation system screen, or any other computing device that is capable of displaying images. The Display Controller 307 renders images on the Display 308.

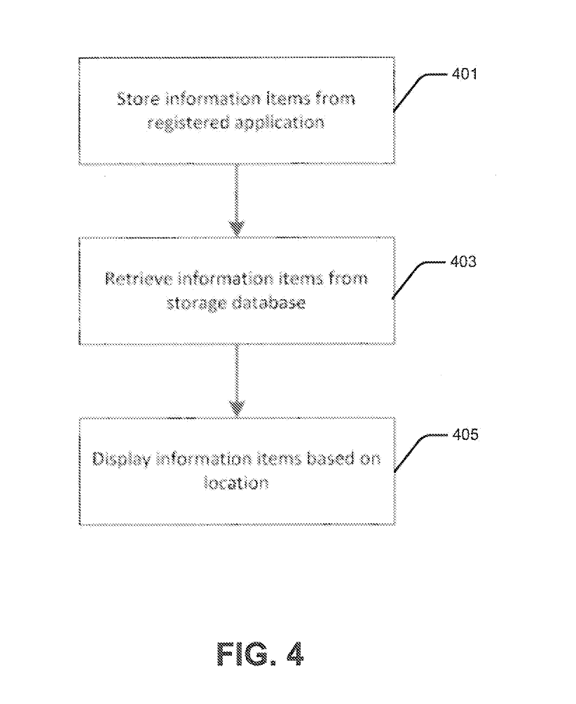

FIG. 4 is a high-level flow diagram illustrating the basic steps involved in generating data and displaying it in accordance with the principles of one embodiment of the present invention. Particularly, in step 401, the Salience Module 304 retrieves and stores in the database 305 the various information items associated with one or more salient locations. In step 403, the Selection Module 306 retrieves the subset of those information items that are indexed to a location having a predetermined relationship to (e.g., within a predetermined distance of) a user-selected or current location. Finally, in step 405, the Display Controller 307 controls the Display Device 308 to display the information items and/or their salient locations to the user in a useful manner.

With regard to retrieving and storing the information items and their corresponding location data from registered applications (step 401 in FIG. 4), there are many ways that the Salience Module 304 can identify information items that are somehow related to a geographic location. Certain techniques can be generally useful in connection with many different types of registered applications. Others will be specific to one or a few particular types of registered applications.

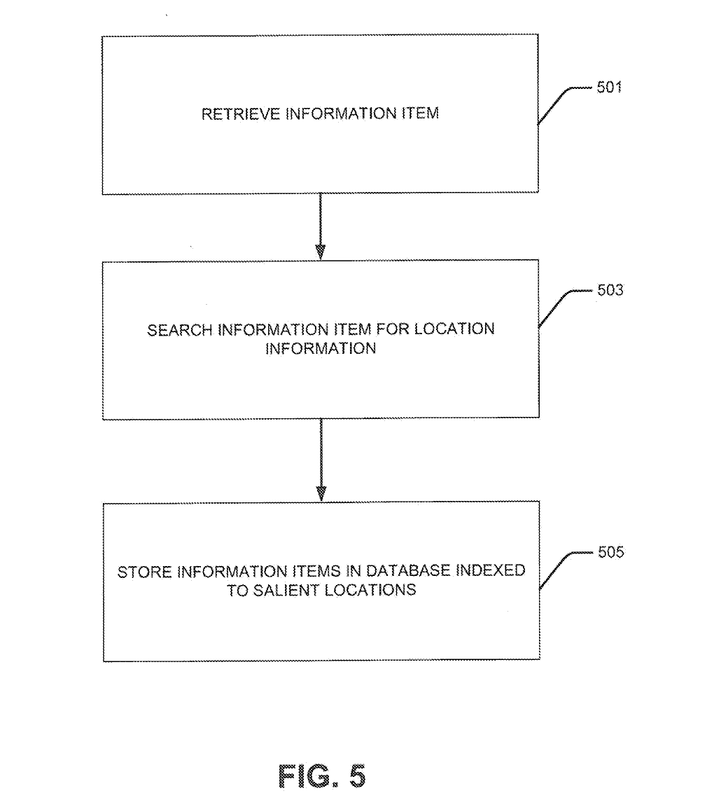

FIG. 5 is a flow diagram illustrating one exemplary embodiment of a technique of retrieving and storing information items indexed to salient locations. In step 501, the Salience Module 304 retrieves an information item (e.g., an email if an email application, an appointment if a calendar application, etc.). In step 503, the Salience Module parses the information item in search of location information. This may comprise many possible techniques, including searching text for the names of locations that correspond to locations listed in a location database. The database of location names can be based on a combination of publicly available lists of countries, cities, airports, counties, historical sites, tourist attractions, and so on. Examples of such lists include http://en.wikipedia.org/wiki/List_of_U.S._National_Historic_Landmarks_by_state and http://en.wikipedia.org/wiki/Lists_of_tourist_attractions.

Alternately or additionally, it may identify location names mentioned in a text item by relying upon common grammatical patterns associated with locations. This may take many forms. As one example, it may look for proper nouns such as capitalized words (particularly, ones that are not at the beginnings of sentences) and/or words that are surrounded by other words commonly used in association with locations, such as the word “at”, especially preceding a proper noun.

Street addresses may be detected in various formats (http://en.wikipedia.org/wiki/Address_(geography)) from text documents such as emails, and plain text, Word, or PDF documents by their common properties, such as (1) comma separated proper nouns, (2) the use of words such as “street”. “avenue”. “Boulevard”, “road”, etc., (3) numbers followed by words, particularly, proper nouns, (4) zip code-like numeric patterns (five digits or five digits followed by a dash and four more digits), and (6) comparison with a database of addresses. Many such tools exist, such as disclosed at http://smartystreets.com/products/liveaddress-api/extract, which is incorporated herein by reference in its entirety and can be incorporated in the Salience Module.

Speech recognition may be applied to audio files to extract location names spoken in audio and video files. An example approach is the Dragon Audio Mining toolkit: http://www.nuance.com/naturallyspeaking/products/sdk/sdkaudiomining.asp.

Yet further, visual recognition technologies may be used to identify location names from images or videos. For example, the approaches of http://ieeexplore.ieee.org/xpls/abs_all.jsp?arnumber=1251157 and/or http://ieeexplore.ieee.org/xpls/abs_all.jsp?arnumber=817607 may be used.

The Salience Module 304 also may identify location information explicitly provided by an application as metadata. For example, a camera app may provide the GPS coordinates of where a picture was taken. As another example, location information may be explicitly retrieved from an application in a well-identified form, such as origin and destination from a navigation application.

Next, in step 505, the Salience Module 304 stores the information item along with the determined salient location. For instance, the information items may be stored in a database table with a key. Alternately, it may insert the key of an information item in a list of keys specific to an associated location name.

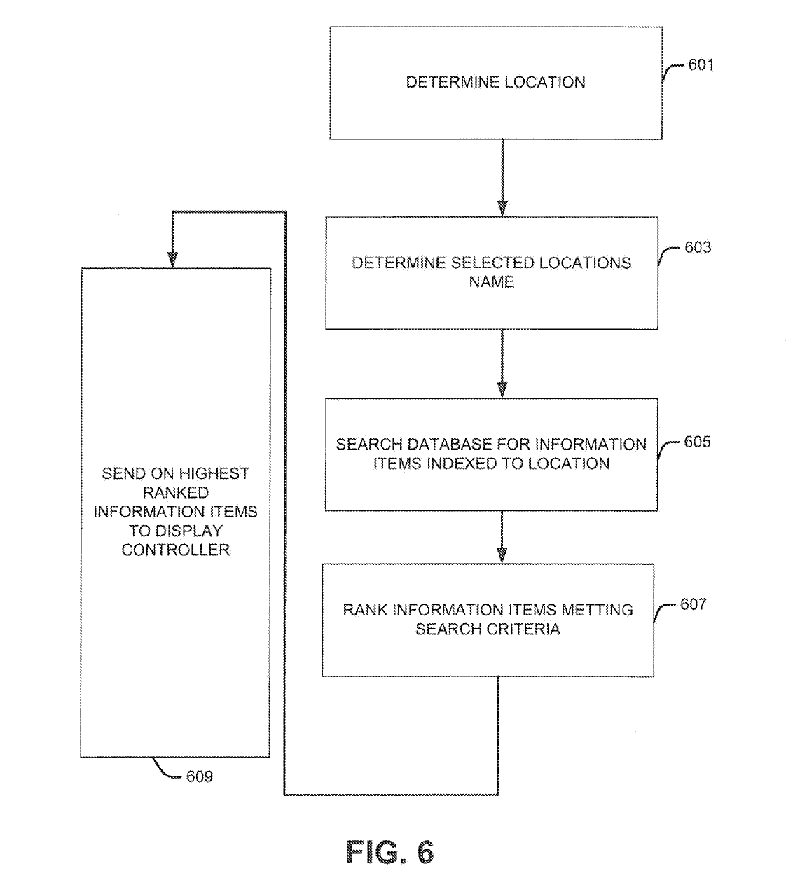

Turning now to step 403 in FIG. 4, i.e., the retrieval of particular information items from the database 305 as a function of the user's current (or otherwise selected) location FIG. 6 is a flow diagram illustrating one exemplary technique for doing so. In step 601, the Selection Module 306 determines the user's location, such as from GPS or network location infrastructure. Alternately, it could allow the user to select any other location. In step 603, the Selection Module determines the current location name from, for instance, a geolocation web service, such as Google Places (https://developers.google.com/places/) or prior user-specific names stored by the user.

In step 605, the Selection Module 306 searches the database 305 for those information items that are indexed to that location, location name, and/or coordinates. It may further be adapted to look for other information items that are indexed to locations near the selected location (such as within a predetermined distance thereof). That predetermined distance may be context-sensitive and/or settable by the user. Finally, as shown in step 607, in some embodiments, the Selection Module 306 may rank the retrieved information items (so that the Display Control Module 307 can cause the display device to show only the most important information items, especially if the number of information items corresponding to a particular location is very large.

Ranking may take many forms. In one exemplary embodiment, the Selection Module 306 assigns points to each information item based on its level of user engagement. For example, it may assign a relatively higher point value, e.g., five points, to an item that contains information provided by the user. It may also assign five points to an information item that contains information produced in response to a user action, such as a query. Furthermore, it may assign one point for each minute that a user stays on the application page that produced that information item. Yet further, it may assign two points for each time that a user returns to the same information item or has the item re-generated through an application or otherwise interacts with the information item. The Selection Module 306 then may add up the points assigned to each information item and rank the information items by their total assigned points. Points also may be assigned as a function of the proximity of the salient location to the user's current position.

Next, in step 609, the Selection Module 306 will chooses the N highest ranked information items for forwarding to the Display Controller 307 which can generate displays such as any of those discussed hereinabove and/or illustrated, where N is an integer.

As previously mentioned, the Location Module 300 may be configured to allow the user to set any number of operational parameters to the user's specific likings. Merely as a few examples, it may permit the user to input additional names of locations of interest (e.g., Home, Work, School). It also may permit the user to provide a list of applications to be registered. Alternately, it may provide a list of registrable applications with checkboxes that the user may check to cause the Location Module to register those applications. Yet further, it may permit the user to select the maximum number of information items to be displayed. In one preferred embodiment, the user may update any of the user settable parameters at any time, including editing or deleting prior entries.

### Exemplary Systems for Implementation of Concepts

The concepts expressed herein may be implemented in connection with cellular telephones and other types of User Equipment (UE) used on communication networks, and particularly wireless communication networks. Described below are one or more exemplary communication networks and related equipment within which at least some of the aspects of the herein described concepts may be implemented.

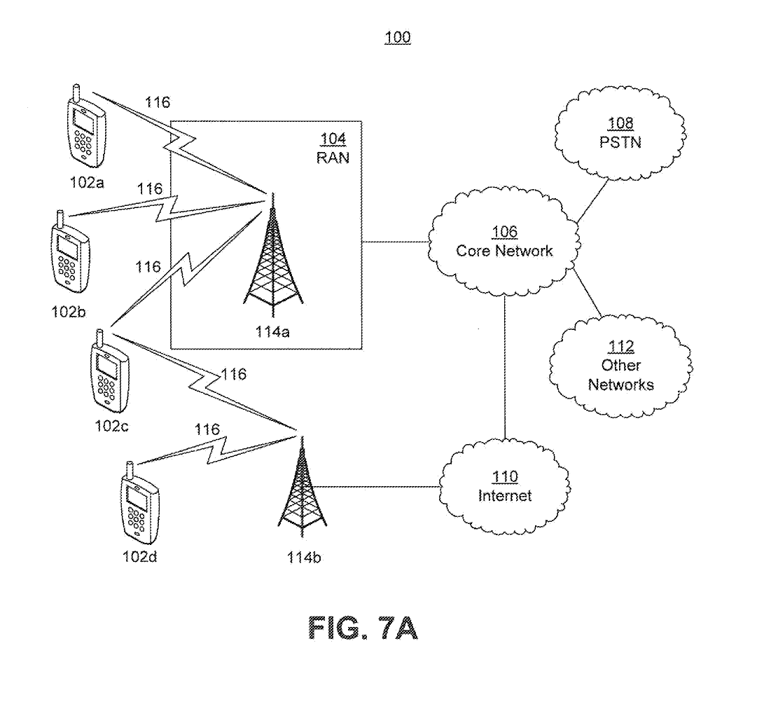

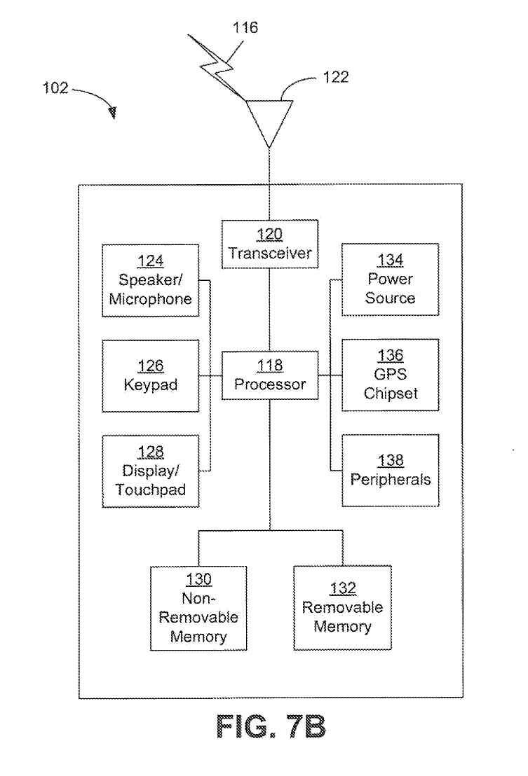

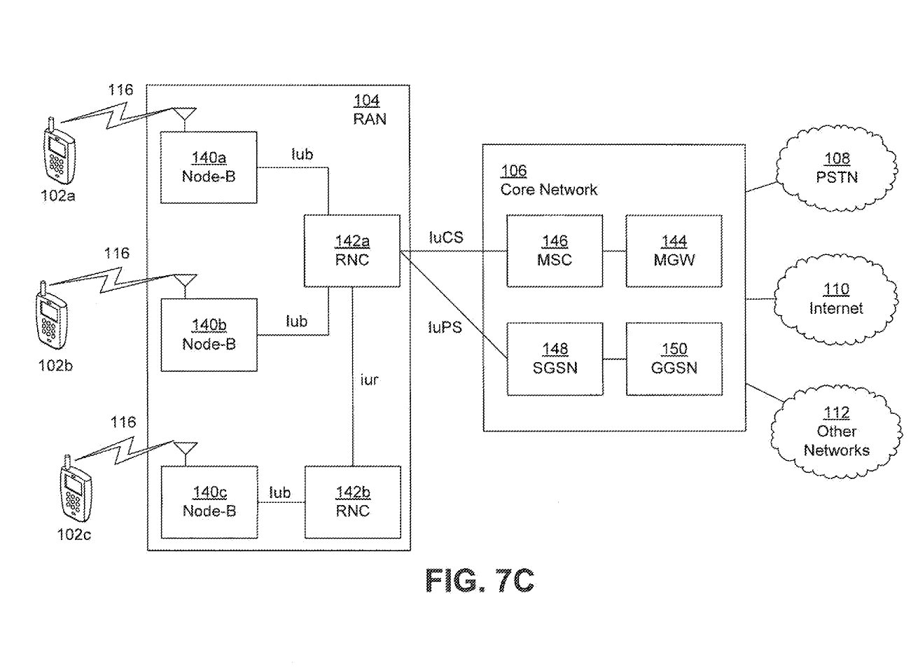

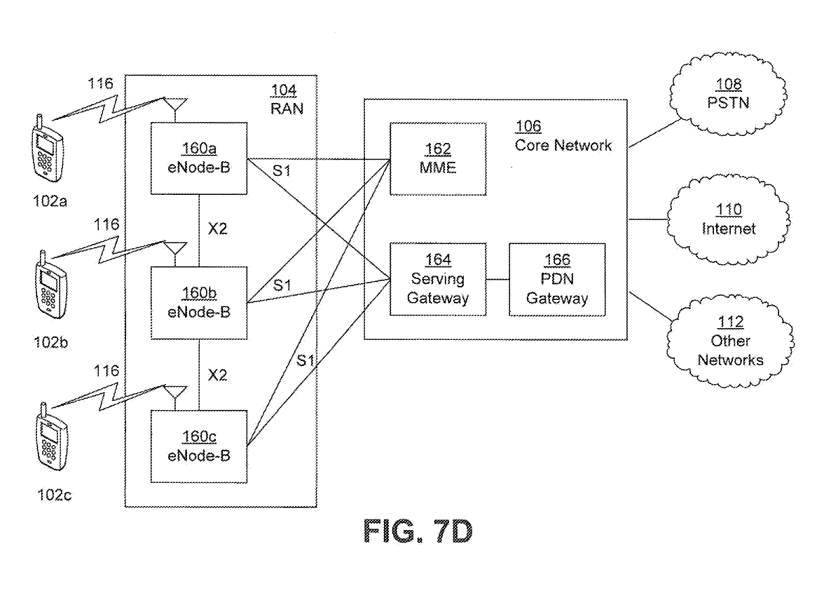

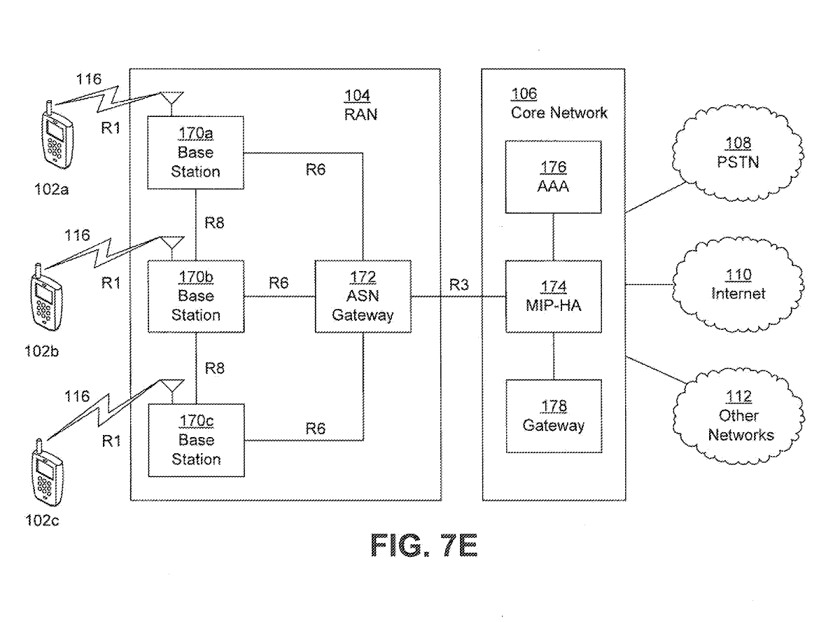

FIG. 7A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 7A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 7A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 7B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 7B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 7B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 7C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 7C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 7C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 7C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 7D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 7D, the eNode-Bs 160a, 160b, 160c may communicate with one another over an X2 interface.

The core network 106 shown in FIG. 7D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 7E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 7E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 7E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator.

The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers.

Although not shown in FIG. 7E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

### Embodiments

In one embodiment, a method is implemented in a communication device of organizing location-specific information from a plurality of software applications, comprising: interfacing with each of the plurality of software applications to gain access to information items available through the software applications; searching the information items for location-specific data indicative of a location salient to the information item; causing a database to index the information items as a function of the salient locations; responsive to a location-specific event corresponding to a specific location, identifying information items in the database having salient locations having a particular geographic relationship to the specific location; and controlling a display device to display a representation of the identified information items on the mobile communication device.

In accordance with this embodiment, the method may further comprise wherein the representation of the information item includes a summary of the information item.

Any of the preceding embodiments may further comprise wherein the summary comprises a textual description.

Any of the preceding embodiments may further comprise wherein the controlling comprises causing the display device to display representations of the information items in map form.

Any of the preceding embodiments may further comprise wherein the particular geographic relation is being within a first distance of the specific location.

Any of the preceding embodiments may further comprise wherein the controlling a display device further comprises displaying the specific location relative to the locations to which the information items being represented on the display correspond.

Any of the preceding embodiments may further comprise wherein the specific location comprises an area and the particular geographic relation is being within the area.

Any of the preceding embodiments may further comprise wherein the controlling comprises causing the display device to display the representation of the retrieved information items in list form.

Any of the preceding embodiments may further comprise wherein the controlling comprises causing the display device to display the representations of the information items in positions on the display device relative to each other representative of the relative positions of the salient locations of the information items.

Any of the preceding embodiments may further comprise controlling the display device to display a plurality of locations from which a user may select the specific location; wherein the selection of the specific location is the location-specific event.

Any of the preceding embodiments may further comprise wherein the displaying a plurality of locations comprises displaying a plurality of location icons, each location icon corresponding to at least one of the plurality of locations, and wherein each of the location icons includes a representation of a number of information items having salient locations having the particular geographic relationship to the corresponding location.

Any of the preceding embodiments may further comprise wherein each of the location icons includes a plurality of representations of a number of information items, each representation of a number of information items for each location icon indicating a number of information items of a particular type.

Any of the preceding embodiments may further comprise wherein the types of information items are different software applications from which the information items originated.

Any of the preceding embodiments may further comprise wherein the types of information items are different types of software applications from which the information items originated.

Any of the preceding embodiments may further comprise wherein the different types of software applications include at least two of email applications, word processing applications, navigation applications, calendar applications, and web browser applications.

Any of the preceding embodiments may further comprise: permitting a user to interact with the location icons to select an icon; and, responsive to the user's selection of a location icon, displaying a representation of each information item having the predetermined geographic relationship to the location corresponding to the selected location icon.

Any of the preceding embodiments may further comprise wherein the representations of the information items are displayed overlaid on a map.

Any of the preceding embodiments may further comprise permitting a user to interact with the displayed representations of the information items to select a displayed information item, and, responsive to the user's selection of an information item, opening the selected information item.

Any of the preceding embodiments may further comprise wherein the opening of the selected information item comprises opening the software application from which the information item originated.

Any of the preceding embodiments may further comprise wherein the opening of the selected information item further comprises opening the selected information item within the corresponding software application.

Any of the preceding embodiments may further comprise wherein information items comprise at least one of emails in email software applications, documents in word processing software applications, web pages in web browser software applications, appointments in calendar software applications, contacts in software applications, and data in navigation software applications.

Any of the preceding embodiments may further comprise wherein the communication device is a location-aware mobile communication device and the location-specific event comprises the mobile communication device detecting that it is located in a particular location.

Any of the preceding embodiments may further comprise wherein the location-specific event comprises a user input selecting a particular location.

Any of the preceding embodiments may further comprise permitting a user to select the plurality of software applications from which information items may be retrieved.

Any of the preceding embodiments may further comprise correlating the salient location information in the information items to location names.

Any of the preceding embodiments may further comprise assigning ranks to the information items.

Any of the preceding embodiments may further comprise wherein the rank is based on a determined importance of the information item.

Any of the preceding embodiments may further comprise wherein the assigning of ranks to the information items comprises assigning ranks to the information items based at least in part on criteria indicative of user interaction with the information item.

Any of the preceding embodiments may further comprise wherein the criteria include at least one of (1) a length of time the information item was displayed, (2) a number of times the information item was displayed, (3) a number of times a user interacted with the information item, and (4) proximity to the specific location.

Any of the preceding embodiments may further comprise wherein the searching comprises at least one of (1) comparing data in the information items to a database of location names, (2) searching text for grammatical patterns commonly associated with use in connection with location names, (3) searching text for proper nouns, searching text for number patterns commonly associated with addresses or locations, (4) searching text for words commonly associated with locations, (5) searching for metadata containing location information, (6) applying speech recognition to audio files identify location-specific speech, (7) applying visual recognition technology to video files to identify locations depicted in the files.

In another embodiment or in connection with any of the preceding embodiments, a non-transitory computer readable medium containing computer executable instructions for organizing location-specific information from a plurality of software applications, may comprising: computer readable instructions that, when executed a processor, cause the processor to interface with each of the plurality of software applications to gain access to information items available through the software applications; computer readable instructions that, when executed a processor, cause the processor to search the information items to identify location-specific data in the information items indicative of a location salient to the information item; computer readable instructions that, when executed a processor, cause the processor to cause a database to index the information items as a function of the salient locations; computer readable instructions that, when executed a processor, cause the processor to, responsive to a location-specific event corresponding to a specific location, identify information items in the database having salient locations having a particular geographic relationship to the specific location; and computer readable instructions that, when executed a processor, cause the processor to control a display device to display a representation of the identified information items on the mobile communication device.

Any of the preceding embodiments may further comprise wherein the computer readable instructions that cause the processor to control a display device to display a representation of the identified information items causes the information item includes a summary of the information item.

Any of the preceding embodiments may further comprise wherein the summary comprises a textual description.

Any of the preceding embodiments may further comprise wherein the computer readable instructions that cause the processor to control a display device causes the display device to display representations of the information items in map form.

Any of the preceding embodiments may further comprise wherein the particular geographic relation is being within a first distance of the specific location.

Any of the preceding embodiments may further comprise wherein the computer readable instructions that cause the processor to control a display device causes the display device to display the specific location relative to the locations to which the information items being represented on the display correspond.

Any of the preceding embodiments may further comprise wherein the specific location comprises an area and the particular geographic relation is being within the area.

Any of the preceding embodiments may further comprise wherein the computer readable instructions that cause the processor to control a display device comprises computer readable instructions that cause the display device to display the representation of the retrieved information items in list form.

Any of the preceding embodiments may further comprise wherein the computer readable instructions that cause the processor to control a display device comprises computer readable instructions that cause the display device to display the representations of the information items in positions on the display device relative to each other representative of the relative positions of the salient locations of the information items.

Any of the preceding embodiments may further comprise computer readable instructions that, when executed, control the display device to display a plurality of locations from which a user may select the specific location, wherein the selection of the specific location is the location-specific event.

Any of the preceding embodiments may further comprise wherein the computer readable instructions that cause the processor to display a plurality of locations comprises computer readable instructions that cause the display to display a plurality of location icons, each location icon corresponding to at least one of the plurality of locations, and wherein each of the location icons includes a representation of a number of information items having salient locations having the particular geographic relationship to the corresponding location.

Any of the preceding embodiments may further comprise wherein the computer readable instructions that cause the display to display a plurality of location icons wherein each of the location icons includes a plurality of representations of a number of information items, each representation of a number of information items for each location icon indicating a number of information items of a particular type.

Any of the preceding embodiments may further comprise wherein the types of information items are different software applications from which the information items originated.

Any of the preceding embodiments may further comprise wherein the types of information items are different types of software applications from which the information items originated.

Any of the preceding embodiments may further comprise wherein the different types of software applications include at least two of email applications, word processing applications, navigation applications, calendar applications, and web browser applications.

Any of the preceding embodiments may further comprise computer readable instructions that, when executed, permit a user to interact with the location icons to select an icon and, responsive to the user's selection of a location icon, display a representation of each information item having the predetermined geographic relationship to the location corresponding to the selected location icon.

Any of the preceding embodiments may further comprise wherein the representations of the information items are displayed overlaid on a map.

Any of the preceding embodiments may further comprise computer readable instructions that, when executed, permit a user to interact with the displayed representations of the information items to select a displayed information item, and, responsive to the user's selection of an information item, open the selected information item.

Any of the preceding embodiments may further comprise wherein the computer executable instructions that open the selected information item comprise computer executable instructions that open the software application from which the information item originated.

Any of the preceding embodiments may further comprise wherein the computer executable instructions that open the selected information item comprise further comprise computer executable instructions that open the selected information item within the corresponding software application.

Any of the preceding embodiments may further comprise wherein information items comprise at least one of emails in email software applications, documents in word processing software applications, web pages in web browser software applications, appointments in calendar software applications, contacts in software applications, and data in navigation software applications.

Any of the preceding embodiments may further comprise wherein the location-specific event comprises a mobile communication device detecting that it is located in a particular location.

Any of the preceding embodiments may further comprise wherein the location-specific event comprises a user input selecting a particular location.

Any of the preceding embodiments may further comprise computer readable instructions that, when executed, permit a user to select the plurality of software applications from which information items may be retrieved.

Any of the preceding embodiments may further comprise computer readable instructions that, when executed, correlate the salient location information in the information items to location names.

Any of the preceding embodiments may further comprise computer readable instructions that, when executed, assign ranks to the information items.

Any of the preceding embodiments may further comprise wherein the rank is based on a determined importance of the information item.

Any of the preceding embodiments may further comprise wherein the computer readable instructions that assign ranks to the information items assigns ranks to the information items based at least in part on criteria indicative of user interaction with the information item.

Any of the preceding embodiments may further comprise wherein the criteria include at least one of (1) a length of time the information item was displayed, (2) a number of times the information item was displayed, (3) a number of times a user interacted with the information item, and (4) proximity to the specific location.

Any of the preceding embodiments may further comprise wherein the computer executable instructions that search comprise computer executable instructions that perform at least one of (1) comparing data in the information items to a database of location names, (2) searching text for grammatical patterns commonly associated with use in connection with location names, (3) searching text for proper nouns, searching text for number patterns commonly associated with addresses or locations, (4) searching text for words commonly associated with locations, (5) searching for metadata containing location information, (6) applying speech recognition to audio files identify location-specific speech, (7) applying visual recognition technology to video files to identify locations depicted in the files.

In another embodiment, or in connection with any of the preceding embodiments, a wireless transmit receive unit (WTRU) may comprise: a transmitter; a receiver; and a processor configured to (1) interface with each of the plurality of software applications to gain access to information items available through the software applications;

search the information items for location-specific data indicative of a location salient to the information item, (2) cause a database to index the information items as a function of the salient locations, (3) responsive to a location-specific event corresponding to a specific location, identify information items in the database having salient locations having a particular geographic relationship to the specific location, and (4) control a display device to display a representation of the identified information items on the mobile communication device.

Any of the preceding embodiments may further comprise circuitry for determining a location of the WTRU.

Any of the preceding embodiments may further comprise wherein the representation of the information item includes a summary of the information item.

Any of the preceding embodiments may further comprise wherein the summary comprises a textual description.

Any of the preceding embodiments may further comprise wherein the controlling the display device comprises causing the display device to display representations of the information items in map form.

Any of the preceding embodiments may further comprise wherein the particular geographic relation is being within a first distance of the specific location.

Any of the preceding embodiments may further comprise wherein the controlling a display device further comprises displaying the specific location relative to the locations to which the information items being represented on the display correspond.

Any of the preceding embodiments may further comprise wherein the specific location comprises an area and the particular geographic relation is being within the area.

Any of the preceding embodiments may further comprise wherein the controlling comprises causing the display device to display the representation of the retrieved information items in list form.

Any of the preceding embodiments may further comprise wherein the controlling comprises causing the display device to display the representations of the information items in positions on the display device relative to each other representative of the relative positions of the salient locations of the information items.

Any of the preceding embodiments may further comprise controlling the display device to display a plurality of locations from which a user may select the specific location, wherein the selection of the specific location is the location-specific event.

Any of the preceding embodiments may further comprise wherein the displaying a plurality of locations comprises displaying a plurality of location icons, each location icon corresponding to at least one of the plurality of locations, and wherein each of the location icons includes a representation of a number of information items having salient locations having the particular geographic relationship to the corresponding location.

Any of the preceding embodiments may further comprise wherein each of the location icons includes a plurality of representations of a number of information items, each representation of a number of information items for each location icon indicating a number of information items of a particular type.

Any of the preceding embodiments may further comprise wherein the types of information items are different software applications from which the information items originated.

Any of the preceding embodiments may further comprise wherein the types of information items are different types of software applications from which the information items originated.

Any of the preceding embodiments may further comprise wherein the different types of software applications include at least two of email applications, word processing applications, navigation applications, calendar applications, and web browser applications.

Any of the preceding embodiments may further comprise wherein the processor is further configured to permit a user to interact with the location icons to select an icon, and, responsive to the user's selection of a location icon, display a representation of each information item having the predetermined geographic relationship to the location corresponding to the selected location icon.

Any of the preceding embodiments may further comprise wherein the representations of the information items are displayed overlaid on a map.

Any of the preceding embodiments may further comprise wherein the processor is further configured to permit a user to interact with the displayed representations of the information items to select a displayed information item and, responsive to the user's selection of an information item, open the selected information item.

Any of the preceding embodiments may further comprise wherein the opening of the selected information item comprises opening the software application from which the information item originated.

Any of the preceding embodiments may further comprise wherein the opening of the selected information item further comprises opening the selected information item within the corresponding software application.

Any of the preceding embodiments may further comprise wherein information items comprise at least one of emails in email software applications, documents in word processing software applications, web pages in web browser software applications, appointments in calendar software applications, contacts in software applications, and data in navigation software applications.

Any of the preceding embodiments may further comprise wherein the location-specific event comprises the WTRU detecting that it is located in a particular location.

Any of the preceding embodiments may further comprise wherein the location-specific event comprises a user input selecting a particular location.

Any of the preceding embodiments may further comprise permitting a user to select the plurality of software applications from which information items may be retrieved.

Any of the preceding embodiments may further comprise wherein the processor is further configured to correlate the salient location information in the information items to location names.

Any of the preceding embodiments may further comprise wherein the processor is further configured to assign ranks to the information items.

Any of the preceding embodiments may further comprise wherein the rank is based on a determined importance of the information item.

Any of the preceding embodiments may further comprise wherein the assigning of ranks to the information items comprises assigning ranks to the information items based at least in part on criteria indicative of user interaction with the information item.

Any of the preceding embodiments may further comprise wherein the criteria include at least one of (1) a length of time the information item was displayed, (2) a number of times the information item was displayed, (3) a number of times a user interacted with the information item, and (4) proximity to the specific location.

Any of the preceding embodiments may further comprise wherein the searching comprises at least one of (1) comparing data in the information items to a database of location names, (2) searching text for grammatical patterns commonly associated with use in connection with location names, (3) searching text for proper nouns, searching text for number patterns commonly associated with addresses or locations, (4) searching text for words commonly associated with locations, (5) searching for metadata containing location information, (6) applying speech recognition to audio files identify location-specific speech, (7) applying visual recognition technology to video files to identify locations depicted in the files.

### CONCLUSION

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a communication device of organizing location-specific information from a plurality of software applications, the method comprising:
interfacing with each of the plurality of software applications to gain access to information items available through the software applications;
searching the information items for location-specific data indicative of a location salient to the information item;
causing a database to index the information items as a function of the salient locations;
responsive to a location-specific event corresponding to a specific location, identifying information items in the database having salient locations having a particular geographic relationship to the specific location; and
controlling a display device to display a representation of the identified information items on the mobile communication device.

2. The method of claim 1 wherein the representation of the information item includes a summary of the information item.

3. The method of claim 1 wherein the controlling comprises causing the display device to display representations of the information items in map form.

4. The method of claim 3 wherein the particular geographic relation is being within a first distance of the specific location.

5. The method of claim 1 wherein the specific location comprises an area and the particular geographic relation is being within the area.

6. The method of claim 4 wherein the controlling comprises causing the display device to display the representations of the information items in positions on the display device relative to each other representative of the relative positions of the salient locations of the information items.

7. The method of claim 6 further comprising:
controlling the display device to display a plurality of locations from which a user may select the specific location;
wherein the selection of the specific location is the location-specific event.

8. The method of claim 7 wherein the displaying a plurality of locations comprises displaying a plurality of location icons, each location icon corresponding to at least one of the plurality of locations, and wherein each of the location icons includes a representation of a number of information items having salient locations having the particular geographic relationship to the corresponding location.

9. The method of claim 8 further comprising:
permitting a user to interact with the location icons to select an icon; and
responsive to the user's selection of a location icon, displaying a representation of each information item having the predetermined geographic relationship to the location corresponding to the selected location icon.

10. The method of claim 1 further comprising:
permitting a user to interact with the displayed representations of the information items to select a displayed information item; and
responsive to the user's selection of an information item, opening the selected information item.

11. The method of claim 1 wherein information items comprise at least one of emails in email software applications, documents in word processing software applications, web pages in web browser software applications, appointments in calendar software applications, contacts in software applications, and data in navigation software applications.

12. The method of claim 1 wherein the communication device is a location-aware mobile communication device and the location-specific event comprises the mobile communication device detecting that it is located in a particular location.

13. The method of claim 1 further comprising:
correlating the salient location information in the information items to location names.

14. The method of claim 1 further comprising:
assigning ranks to the information items based on a determined importance of the information item, wherein the assigning of ranks to the information items comprises assigning ranks to the information items based at least in part on criteria indicative of user interaction with the information item.

15. The method of claim 14 wherein the criteria include at least one of (1) a length of time the information item was displayed, (2) a number of times the information item was displayed, (3) a number of times a user interacted with the information item, and (4) proximity to the specific location.

16. The method of claim 1 wherein the searching comprises at least one of (1) comparing data in the information items to a database of location names, (2) searching text for grammatical patterns commonly associated with use in connection with location names, (3) searching text for proper nouns, searching text for number patterns commonly associated with addresses or locations, (4) searching text for words commonly associated with locations, (5) searching for metadata containing location information, (6) applying speech recognition to audio files identify location-specific speech, (7) applying visual recognition technology to video files to identify locations depicted in the files.

17. A non-transitory computer readable medium containing computer executable instructions for organizing location-specific information from a plurality of software applications, comprising:
computer readable instructions that, when executed a processor, cause the processor to interface with each of the plurality of software applications to gain access to information items available through the software applications;
computer readable instructions that, when executed a processor, cause the processor to search the information items to identify location-specific data in the information items indicative of a location salient to the information item;
computer readable instructions that, when executed a processor, cause the processor to cause a database to index the information items as a function of the salient locations;
computer readable instructions that, when executed a processor, cause the processor to, responsive to a location-specific event corresponding to a specific location, identify information items in the database having salient locations having a particular geographic relationship to the specific location; and
computer readable instructions that, when executed a processor, cause the processor to control a display device to display a representation of the identified information items on the mobile communication device.

18. The computer readable medium of claim 17 further comprising:
computer readable instructions that, when executed, permit a user to interact with the displayed representations of the information items to select a displayed information item, and, responsive to the user's selection of an information item, open the selected information item.

19. The computer readable medium of claim 17 wherein the location-specific event comprises a mobile communication device detecting that it is located in a particular location.

20. The computer readable medium of claim 17 further comprising:
computer readable instructions that, when executed, assign ranks to the information items based on a determined importance of the information item based at least in part on criteria indicative of user interaction with the information item.

21. A wireless transmit receive unit (WTRU) comprising;
a transmitter;
a receiver;
a processor configured to:
interface with each of the plurality of software applications to gain access to information items available through the software applications;
search the information items for location-specific data indicative of a location salient to the information item;
cause a database to index the information items as a function of the salient locations;
responsive to a location-specific event corresponding to a specific location, identify information items in the database having salient locations having a particular geographic relationship to the specific location; and
control a display device to display a representation of the identified information items on the mobile communication device.

22. The WTRU of claim 21 further comprising circuitry for determining a location of the WTRU and wherein the location-specific event comprises the WTRU detecting that it is located in a particular location.
